(19) United States
(12) Patent Application Publication
(10) Pub. No.: US 2005/0080681 A1
(43) Pub. Date: Apr. 14, 2005

(54) System for providing information of automatic transaction apparatus

(76) Inventor: Shinichi Ohnishi, Saitama (JP)

Correspondence Address: RABIN & Berdo, PC, 1101 14TH STREET, NW, SUITE 500, WASHINGTON, DC, 20005, US

(21) Appl. No.: 10/938,558

(22) Filed: Sep. 13, 2004

(30) Foreign Application Priority Data
Oct. 8, 2003 (JP) JP2003-349373

(51) Int. Cl. G06F 17/60

(52) U.S. Cl. 705/24

(57) ABSTRACT

An automatic transaction apparatus information providing system has an automatic transaction apparatus which executes a financial transaction, and a customer relationship management server which forms guide information of contents corresponding to a customer who operates the automatic transaction apparatus on the basis of a customer ID of the customer, wherein the guide information is displayed during the financial transaction, and a read code showing detailed information of the guide information is provided. By operating the automatic transaction apparatus by the customer, the read code in which additional information has been stored can be fetched into a PDA of the customer. He can confirm his interested information at desired time and place.

### BACKGROUND OF THE INVENTION

1. Field of the Invention

The invention relates to a system for providing information of an automatic transaction apparatus.

2. Related Background Art

Hitherto, there has been provided a system constructed in such a manner that when a customer of a financial institution such as bank, post office, credit bank, or the like executes a financial transaction such as money receipts, payment, transfer, inquiry for the balances, or the like, if he uses an automatic transaction apparatus such as ATM (Automatic Teller Machine), CD (Cash Dispenser), or the like arranged in a branch office, that is, a service office of the financial institution, in addition to instruction for an operating method of the automatic transaction apparatus, information regarding the financial transaction such as transaction amount, or the like, additional information such as message, advertisement, notification, or the like to the customer from the financial institution is displayed onto a display screen of the automatic transaction apparatus or printed onto a transaction itemized account.

For example, when the customer operates the automatic transaction apparatus in the bank in order to inquire the balances and finishes the operation, information such as “In our bank, new xx services were started from o month o day. Please use them.” is displayed on the display screen and, thereafter, the display is returned to an initial display screen. Further, the information is printed into a margin of an upper edge portion or a lower edge portion of a printed itemized account of the inquiry for the balances.

Since the above system can be changed day after day or every service office, the services which are provided by the financial institution, that is, financial products can be timely informed to the customer and proper information suitable for a region can be transferred to the customer.

When a fault occurs in the automatic transaction apparatus, information such as “Cannot be handled. Please come to the window during office hours.” is displayed on the display screen, thereby guiding the customer to the window. In this case, a proper action can be performed even when a trouble such as a failure of the automatic transaction apparatus occurs.

Further, in recent years, a message of contents corresponding to each customer can be formed by using a CRM (Customer Relationship Management) system (for example, refer to Japanese Patent Application 2002-155078). In this case, what is called a made-to-order message having the contents corresponding to the customer is formed on the basis of information regarding fundamental attributes of the customer such as address, name, age, type of occupation, income, family construction, and the like of each customer and information such as a history or the like regarding an account transaction of each customer performed in the past, and can be presented to the customer.

Thus, the financial institution can provide a service for timely presenting a message regarding the financial products of the contents suitable for each customer or the like to the customer and provide a proper service of a proper expression or the like suitable for each customer to the customer. The customer can also receive proper familiar services with respect to the financial products suitable for himself without receiving unnecessary services such as an unnecessary message and the like.

However, in the conventional system, since it is necessary to shorten a time which is required for the financial transaction using the automatic transaction apparatus, only the additional information of a small amount such as advertisement or simple guidance regarding the financial products can be provided. Since the additional information is displayed on the display screen of the automatic transaction apparatus, the customer cannot carefully examine the contents of the additional information. Although the additional information can be also printed into the margin of the upper edge portion or the lower edge portion of the transaction itemized account such as an itemized account of the inquiry for the balances, in this case, since a space of the margin is narrow, an amount of additional information which is provided is further reduced.

### SUMMARY OF THE INVENTION

It is an object of the invention to solve the problems in the conventional system as mentioned above and provide a system for providing information of an automatic transaction apparatus, in which the customer operates the automatic transaction apparatus, thereby enabling a read code in which additional information has been stored to be fetched into a personal digital assistant which the customer has, and he can confirm his interested information at desired time and place.

According to the present invention, there is provided an automatic transaction apparatus information providing system comprising:
an automatic transaction apparatus which executes a financial transaction; and a customer relationship management server which forms guide information of contents corresponding to a customer who operates the automatic transaction apparatus on the basis of a customer ID of the customer,
wherein the automatic transaction apparatus displays the guide information during the financial transaction, and a read code showing detailed information of the guide information is provided.

In the automatic transaction apparatus information providing system, the automatic transaction apparatus displays the read code so that it can be photographed.

Further, in the automatic transaction apparatus information providing system, the automatic transaction apparatus prints the read code.

Further, in the automatic transaction apparatus information providing system, the automatic transaction apparatus transfers the read code.

Further, the automatic transaction apparatus information providing system may more comprise a read code forming unit which forms the read code every the customer.

Further, in the automatic transaction apparatus information providing system, the read code may be a QR code.

Further, in the automatic transaction apparatus information providing system, the read code may be fetched into a personal digital assistant of the customer.

Further, according to the present invention, there is provided an automatic transaction apparatus comprising:
an ID obtaining unit which obtains a customer ID of a customer; and a customer operation unit which displays guide information of contents corresponding to the customer,
wherein the guide information is displayed during a financial transaction, and a read code showing detailed information of the guide information is provided.

In the automatic transaction apparatus, the read code is displayed to the customer operation unit so that it can be photographed.

Further, the automatic transaction apparatus may more comprise a print unit which prints a transaction itemized account and issues it, and wherein the print unit prints the read code onto the transaction itemized account.

Further, in the automatic transaction apparatus, the read code may be transferred.

Further, in the automatic transaction apparatus, the read code may be a QR code.

Further, in the automatic transaction apparatus, the read code may be fetched into a personal digital assistant of the customer.

The above and other objects and features of the present invention will become apparent from the following detailed description and the appended claims with reference to the accompanying drawings.

### BRIEF DESCRIPTION OF THE DRAWINGS

FIG. 1 is a diagram showing a construction of a system for providing information of an automatic transaction apparatus in the first embodiment of the invention;

FIG. 2 is a diagram showing an example of a QR code in the first embodiment of the invention;

FIG. 3 is a diagram showing an example of information stored in a customer master database in the first embodiment of the invention;

FIG. 4 is a diagram showing an example of information stored in a CRM database in the first embodiment of the invention;

FIG. 5 is a first diagram showing an example of a message display screen of a customer operation unit in the first embodiment of the invention;

FIG. 6 is a second diagram showing an example of the message display screen of the customer operation unit in the first embodiment of the invention;

FIG. 7 is a first diagram showing an example of a display screen of a display apparatus of a personal digital assistant in the first embodiment of the invention;

FIG. 8 is a second diagram showing an example of the display screen of the display apparatus of the personal digital assistant in the first embodiment of the invention;

FIG. 9 is a third diagram showing an example of the display screen of the display apparatus of the personal digital assistant in the first embodiment of the invention;

FIG. 10 is a fourth diagram showing an example of the display screen of the display apparatus of the personal digital assistant in the first embodiment of the invention;

FIG. 11 is a diagram showing an example of a display screen of a display apparatus of a personal digital assistant in the second embodiment of the invention;

FIG. 12 is a diagram showing an example of a transaction itemized account in the third embodiment of the invention;

FIG. 13 is a diagram showing an example of a message display screen of a customer operation unit in the fourth embodiment of the invention; and

FIG. 14 is a diagram showing the operation for transferring a QR code from an automatic transaction apparatus to a personal digital assistant in the fourth embodiment of the invention.

### DETAILED DESCRIPTION OF THE PREFERRED EMBODIMENTS

Embodiments of the invention will now be described in detail hereinbelow with reference to the drawings.

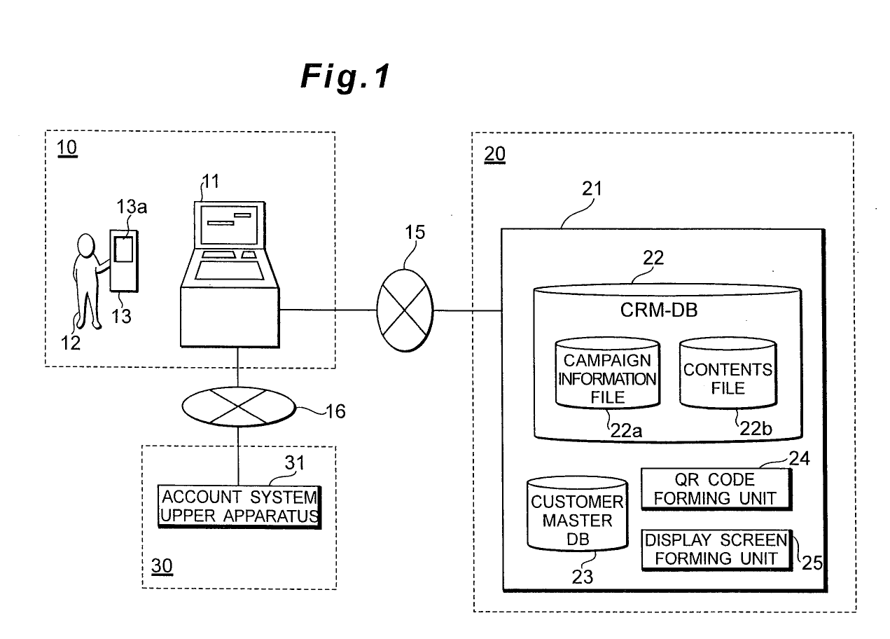

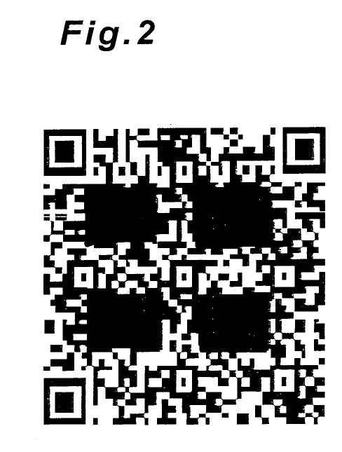

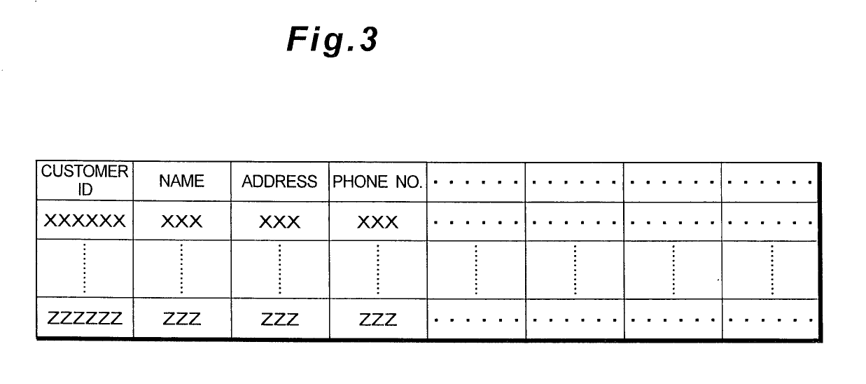

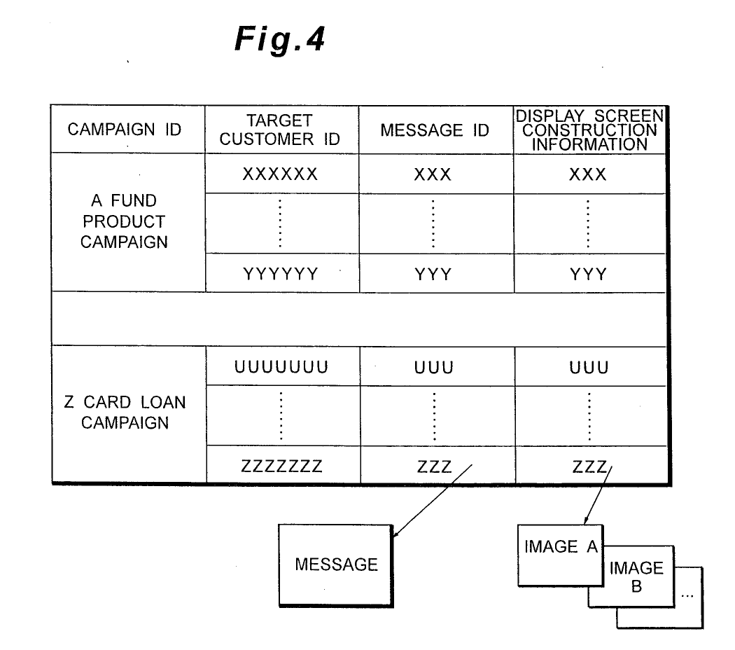

FIG. 1 is a diagram showing a construction of a system for providing information of an automatic transaction apparatus in the first embodiment of the invention. FIG. 2 is a diagram showing an example of a QR code in the first embodiment of the invention. FIG. 3 is a diagram showing an example of information stored in a customer master database in the first embodiment of the invention. FIG. 4 is a diagram showing an example of information stored in a CRM database in the first embodiment of the invention.

In FIG. 1, reference numeral 10 denotes a service office system as a computer system arranged in a service office as a branch office or the like of a financial institution such as bank, credit bank, post office, consumer finance company, or the like. Reference numeral 11 denotes an automatic transaction apparatus such as ATM, CD, or the like arranged in the service office. The automatic transaction apparatus 11 is an apparatus which is used by a customer 12 of the financial institution to operate it by himself and execute a financial transaction such as money receipts, payment, book-keeping, inquiry for the balances, transfer, money transfer, remittance, time deposit setting, or the like. The automatic transaction apparatus 11 can be also replaced with a multifunction terminal such as a kiosk terminal having other functions such as ticket reserving function, products purchase applying function, credit confirming function of a credit card, facility information guiding function, and the like. The customer 12 is a person who opens his own account in the financial institution and uses the financial institution. Although the customer 12 is generally an individual, it can be an enterprise, organization, or the like.

The automatic transaction apparatus 11 has a customer operation unit comprising: an input device such as keyboard, touch panel, mouse, and the like; a display apparatus such as CRT, LCD (Liquid Crystal Display), LED (Light Emitting diode) display, etc.; and the like. It is desirable that the customer operation unit is a touch panel having both functions of the input device and the display apparatus.

The automatic transaction apparatus 11 has a card handling unit as an ID obtaining unit for handling a card such as a cash card or the like and obtaining a customer ID. The card is a card which has been issued to the customer 12 by the financial institution and which is used to execute a financial transaction such as money receipts, payment, transfer, inquiry for the balances, or the like for.

The card has a magnetic stripe for storing information such as name, account number, personal identification number, customer ID, and the like of the customer 12. As a member for storing such information, an IC embedded in a card can be also used in place of the magnetic stripe. The card handling unit has a card slot into which the card is inserted. A conveying apparatus for conveying the card and a recording head such as a magnetic head or the like for executing reading, overwriting, erasure, or the like of information stored in the magnetic stripe of the card or in the IC are arranged in the card slot.

The automatic transaction apparatus 11 can have a book-keeping unit for recording onto a passbook such as a bankbook or the like. In this case, in a manner similar to the card handling unit, the book-keeping unit functions as an ID obtaining unit for obtaining the customer ID and reads financial institution ID information and the information such as name, account number, personal identification number, customer ID, and the like of the customer 12 which have been stored on the magnetic stripe provided for the passbook. As a member for storing the information, an IC embedded in the passbook can be also used in place of the magnetic stripe.

Further, the automatic transaction apparatus 11 has a print unit for printing a transaction itemized account and issuing it. The transaction itemized account is a piece of paper on which the information regarding the financial transaction executed by the customer 12 such as money receipts, payment, book-keeping, inquiry for the balances, transfer, money transfer, remittance, time deposit setting, or the like is printed. An account number, a kind of financial transaction, a transaction amount, and the like are printed. In the embodiment, when the customer 12 operates the customer operation unit and selects a mode in which he consults a teller at a window of the service office, information such as window number, paging number of the customer 12, and the like is also printed onto the transaction itemized account.

The automatic transaction apparatus 11 has: a bill input/output unit which handles bills; and a coin input/output unit which handles coins. Further, the automatic transaction apparatus 11 has: arithmetic operating means such as CPU, MPU, or the like; storing means such as semiconductor memory, magnetic disk, or the like; communicating means; and the like. The automatic transaction apparatus 11 has a control unit which integratedly controls the operation of the automatic transaction apparatus 11. In FIG. 1, although only one automatic transaction apparatus 11 is shown, a plurality of automatic transaction apparatuses can be also used.

The service office system 10 can also have a window terminal and a paging number management system (not shown). In this case, the window terminal is a computer which is arranged at a counter as a service office window and comprises: an arithmetic operating apparatus such as CPU, MPU, or the like; a storing apparatus such as magnetic disk, semiconductor memory, or the like; an input device such as keyboard, mouse, touch panel, and the like; a display apparatus such as CRT, LCD, or the like; a communication interface; a printer; and the like. The operator of a service office as a teller in the bank operates the window terminal and executes a financial process such as deposit, withdrawal, money transfer, book-keeping, or the like and various affairs such as opening of an account, setting of a time deposit, and the like. When the customer 12 operates the input means of the automatic transaction apparatus 11 and selects the mode in which he consults the teller at the window of the service office, the teller obtains various information such as information of the address, name, and the like of the customer 12, customer information which has previously been collected and accumulated, detailed information regarding the financial products and the like, and the like.

The paging number management system is a computer system which is arranged near an entrance of the service office and makes an over-the-counter reception terminal (not shown) operative. The paging number management system has: a server (not shown) as a computer comprising the arithmetic operating apparatus such as CPU, MPU, or the like; the storing apparatus such as magnetic disk, semiconductor memory, or the like; the communication interface; and the like; and one or a plurality of over-the-counter reception terminals which function as clients of the server. The over-the-counter reception terminal comprises: an arithmetic operating apparatus such as CPU, MPU, or the like; a storing apparatus such as magnetic disk, semiconductor memory, or the like; an input device such as keyboard, touch panel, and the like; a display apparatus such as CRT, LCD, or the like; an audio output apparatus such as a speaker or the like; a communication interface; a note-issuing machine for issuing number checks; and the like. When the customer 12 who visits the window of the service office operates the over-the-counter reception terminal by himself and inputs his own matter of business, the address, the name, and the like, information such as corresponding window number, paging number of the customer, waiting time which is presumed, and the like is displayed onto the display apparatus, outputted from the audio output apparatus, or outputted from the note-issuing machine or the like.

Reference numeral 20 denotes a service providing center system as a computer system for providing various services to the customer 12. The service providing center system 20 has a customer relationship management (CRM) server 21 as a subsystem. The service providing center system 20 is connected to a network 15. The service office system 10 is connected to the network 15. The network 15 can be any one of a radio or wire dedicated communication line network, a public communication line network, an Internet, a LAN (Local Area Network), a WAN (Wide Area Network), and the like. Although it is desirable that the network 15 is the dedicated communication line network, a VPN (Virtual Private Network) using the public communication line network can be also used.

In the embodiment, the customer relationship management (CRM) server 21 forms campaign information or the like as contents of services, that is, service contents which are provided in correspondence to the customer 12 on the basis of the customer ID of the customer 12 who operates the automatic transaction apparatus 11.

The CRM server 21 is a kind of computer comprising: an arithmetic operating apparatus such as CPU, MPU, or the like; a storing apparatus such as magnetic disk, semiconductor memory, or the like; an input device such as keyboard, mouse, and the like; a display apparatus such as CRT, LCD, or the like; a communication interface; and the like. The CRM server 21 has a CRM database 22 and a customer master database 23 as a customer database comprising a storing apparatus such as magnetic disk, semiconductor memory, or the like. The CRM database 22 further has a campaign information file 22a and a contents file 22b. The CRM database 22 and the customer master database 23 can be also integratedly constructed in the CRM server 21. The CRM server 21 comprises: a QR code forming unit 24 as a read code forming unit which forms a QR code as a read code; and a display screen forming unit 25 which forms a display screen which is displayed in the customer operation unit of the automatic transaction apparatus 11.

The QR code is one of various read codes which have been proposed in place of the bar code in order to handle a larger information amount in recent years. When comparing the QR code with the bar code on the assumption that they have the same area, since information of about 20 to 100 times as large as that of the bar code can be recorded in the QR code, the QR code is widely used. As shown in FIG. 2, the QR code has a structure in which a number of micro cells, that is, symbols are two-dimensionally arranged and combined and expresses information by bright (white) and dark (black) of each cell. An arbitrary kind of read code can be used in the embodiment. Only the case of using the QR code will be described here.

Display data per customer, campaign information, and the like are stored in the CRM database 22. The campaign information includes a message for campaign and has been stored in the campaign information file 22a. Contents such as message for the customer, display screen constructing information, QR code which has previously been formed, and the like, that is, contents for constructing the display screen which is displayed on the display apparatus of the automatic transaction apparatus 11 have been stored in the contents file 22b. Further, information regarding fundamental attributes of the customer such as customer ID, address, name, age, type of occupation, income, family construction, and the like with respect to each customer, that is, customer fundamental attribute information and account transaction information such as a history or the like regarding the account transaction performed in the past are stored in the customer master database 23. Further, the CRM database 22 has a history database (not shown) in which a providing service history regarding the campaign information or the like as services provided for the customer 12, an operation history regarding the operations of the automatic transaction apparatus 11 and the like which have been executed by the customer 12 so far, and the like are stored.

The customer fundamental attribute information has been stored in, for example, a form as shown in FIG. 3 in the customer master database 23. In this case, a table in which the information such as name, address, telephone number, and the like has been disclosed is stored in the customer master database 23 so as to correspond to the customer ID allocated so as to identify each customer 12. The display data per customer, the campaign information, and the like have been stored in, for example, a form as shown in FIG. 4(a) in the CRM database 22. In this case, a target customer ID showing the customer 12 as a target of each campaign is stored so as to correspond to the campaign ID allocated so as to identify each campaign as a service which is provided for the customer 12 by the financial institution. A message ID showing a message as shown in FIG. 4(b) for introducing the campaign formed for each customer 12 is stored in the campaign information file 22a so as to correspond to the target customer ID. Further, in order to form the campaign information including the message and display it onto the display apparatus in the customer operation unit of the automatic transaction apparatus 11, display screen construction information to construct the display screen showing an image as shown in FIG. 4(c) as contents is stored in the contents file 22b so as to correspond to each message ID.

The QR code forming unit 24 forms a different QR code every customer 12 on the basis of the customer fundamental attribute information of each customer 12, the message to each customer 12, display screen construction information, and the like. The display screen forming unit 25 forms the display screen which is displayed on the display apparatus of the automatic transaction apparatus 11 on the basis of the customer fundamental attribute information, the message, the QR code, and the like.

In FIG. 1, reference numeral 13 denotes a personal digital assistant (PDA) which the customer 12 has. The personal digital assistant 13 comprises: arithmetic operating means such as CPU, MPU, or the like; storing means such as semiconductor memory, magnetic disk, or the like; a display apparatus 13a such as CRT, LCD, or the like; an input device such as keyboard, touch panel, and the like; an audio output apparatus such as a speaker or the like; an audio input apparatus such as a microphone or the like; a communication interface; and the like. Although the personal digital assistant 13 is, for example, a cellular phone, a PHS (Personal Handy-Phone System) telephone, or the like, the personal digital assistant 13 is any of forms such as electronic note, PDA (Personal Digital Assistant), gaming machine, and the like. A camera (not shown) such as a digital camera having an image pickup device such as a CCD (Charge Coupled Device) or the like which can photograph a still image or a motion image is connected to the PDA 13 and the image photographed by the camera can be displayed on the display apparatus 13a. The camera can be also built in the PDA 13. In the case where the camera has a detachable storing medium and can store the image data into the storing medium and the PDA 13 can enclose the storing medium, such a camera does not always need to be connected to the PDA 13. By removing the storing medium from the camera and inserting it into the PDA 13, the image photographed by the camera can be displayed on the display apparatus 13a. In the embodiment, the case where the PDA 13 has the camera therein will now be described.

In the embodiment, the QR code displayed on the display apparatus of the automatic transaction apparatus 11 is photographed by the camera, the PDA 13 decodes the photographed QR code and displays character information, image information, and the like as information showing the QR code on the display apparatus 13a. The QR code can be also displayed on the display apparatus 13a as it is. If the information shown by the QR code is sound information such as music, sound, or the like, it can be also outputted from the sound output apparatus. It is further desirable that the PDA 13 has such a function that it is connected to the Internet and a Web page can be browsed.

In FIG. 1, reference numeral 30 denotes a financial host center system as a computer system for executing affairs of the account system in the financial institution such as various financial processes. The financial host center system 30 has an account system upper apparatus 31 as a computer system, comprising: an arithmetic operating apparatus such as CPU, MPU, or the like; a storing apparatus such as magnetic disk, semiconductor memory, or the like; an input device such as keyboard, mouse, and the like; a display apparatus such as CRT, LCD, or the like; a communication interface; and the like. The account system upper apparatus 31 is an upper apparatus which processes all account transactions which are executed in the financial institution and also has a database for storing account transactions information such as a history and the like regarding the account transactions executed in the past.

The financial host center system 30 is connected to a network 16. The service office system 10 is connected to the network 16. The network 16 can be any one of the radio or wire dedicated communication line network, public communication line network, Internet, LAN, WAN, or the like. Although it is desirable that the network 16 is the dedicated communication line network, the VPN using the public communication line network can be also used. The network 16 can be also the same as the network 15.

The operation of the system for providing the information of the automatic transaction apparatus with the above construction will now be described.

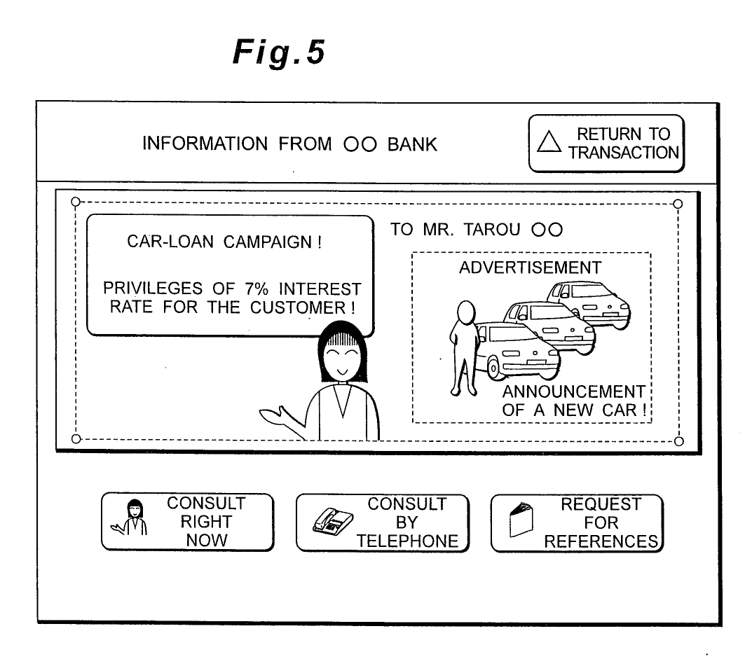

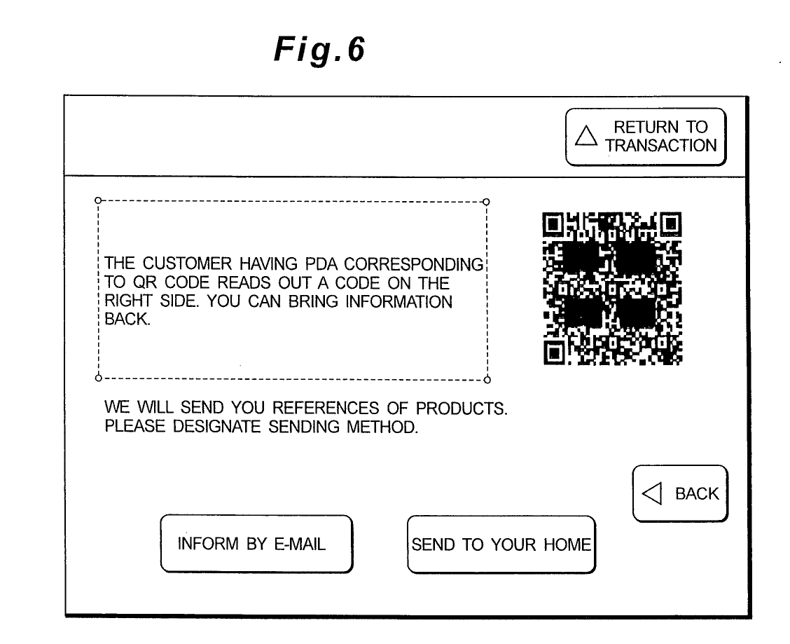

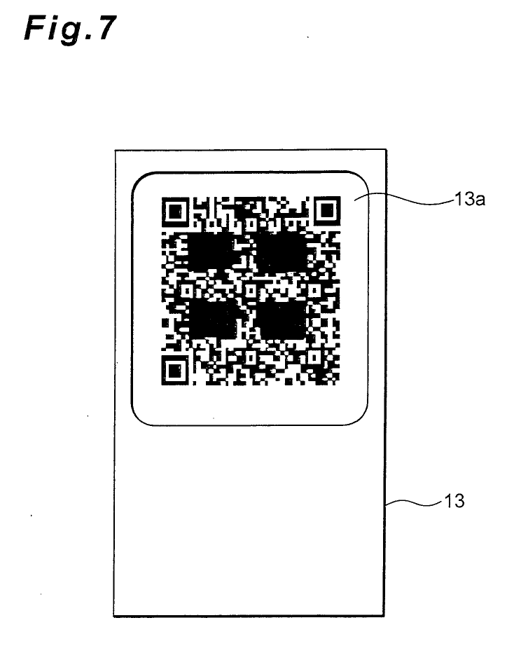

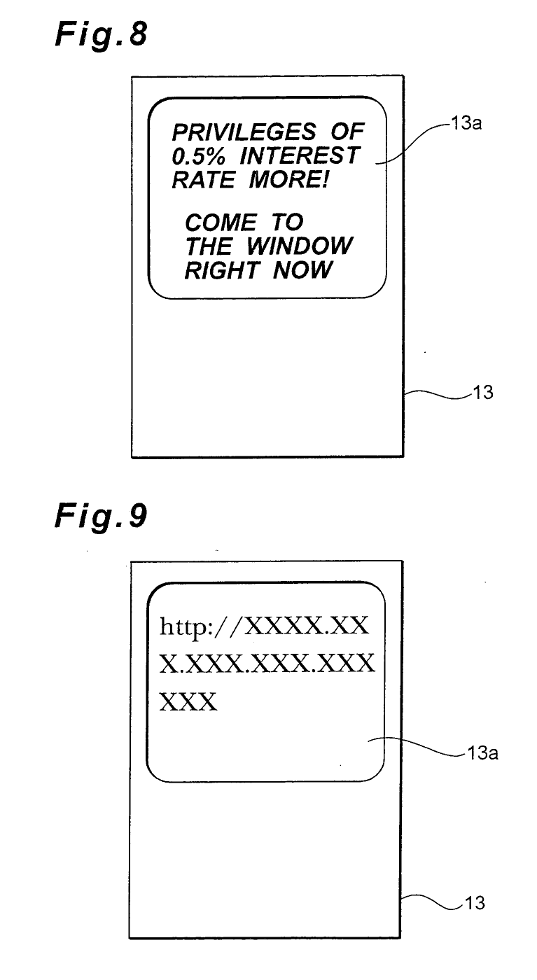

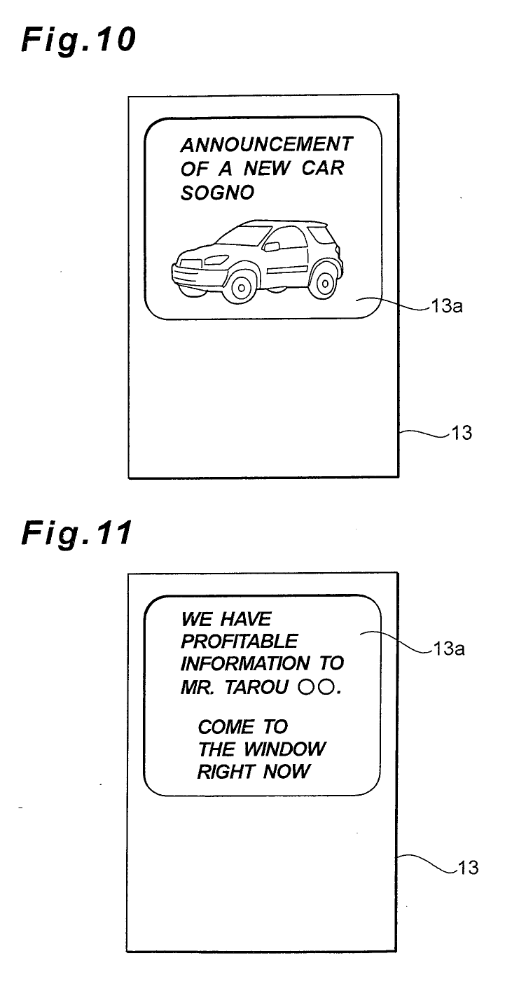

FIG. 5 is a first diagram showing an example of a message display screen of a customer operation unit in the first embodiment of the invention. FIG. 6 is a second diagram showing an example of the message display screen of the customer operation unit in the first embodiment of the invention. FIG. 7 is a diagram showing an example of a display screen of a display apparatus of a personal digital assistant in the first embodiment of the invention. FIG. 8 is a second diagram showing an example of the display screen of the display apparatus of the personal digital assistant in the first embodiment of the invention. FIG. 9 is a third diagram showing an example of the display screen of the display apparatus of the personal digital assistant in the first embodiment of the invention. FIG. 10 is a fourth diagram showing an example of the display screen of the display apparatus of the personal digital assistant in the first embodiment of the invention.

First, the customer 12 executes a financial transaction such as money receipts, payment, book-keeping, inquiry for the balances, or the like by operating the automatic transaction apparatus 11 arranged in the financial institution, a transaction selecting display screen is displayed on the display apparatus of the customer operation unit. The case where the customer operation unit is the touch panel having both functions of the input means and the display means will be described here. In the customer operation unit, the customer 12 selects a desired transaction, for example, the inquiry for the balances from the displayed transactions. For this purpose, the customer 12 touches a key of the inquiry for the balances among the financial transactions displayed on the customer operation unit.

Subsequently, since a display screen for instructing insertion of a card is displayed on the customer operation unit, the customer 12 inserts a cash card into the card slot of the card handling unit. Although the customer 12 can also use a passbook such as a bankbook or the like in place of the card, in the embodiment, the case of using the cash card as a card will now be described. Since a ten-key is also displayed on the customer operation unit together with an instruction for inputting a personal identification number, the customer 12 touches the ten-key and inputs the personal identification number. Thus, a recording head of the card handling unit reads out the customer ID as information stored on the magnetic tape or IC of the cash card. The customer ID is transmitted from the automatic transaction apparatus 11 to the CRM server 21.

When the CRM server 21 receives the customer ID from the automatic transaction apparatus 11, the server 21 accesses the CRM database 22 and discriminates whether or not the campaign information for the customer 12 has been stored. In this case, whether or not the customer ID received from the automatic transaction apparatus 11 has been included in the target customer ID as shown in FIG. 4(a) is discriminated. If it is determined that the customer ID has been included in the target customer ID, that is, the campaign information for the customer 12 has been stored, the CRM server 21 extracts a message based on the message ID corresponding to the target customer ID. On the basis of the display screen construction information corresponding to the target customer ID, the CRM server 21 forms an image signal for displaying the guide information in which the images as shown in FIG. 4(c) are shown as contents onto the customer operation unit of the automatic transaction apparatus 11 and transmits the image signal to the automatic transaction apparatus 11. The extracted message is included in the guide information.

Although the automatic transaction apparatus 11 is executing a process of the transaction affairs (executing a process for counting the received cash or a process for accessing the system of the account system), when the automatic transaction apparatus 11 receives the image signal as service contents which are provided for the customer, it provides services by displaying the guide information including a message as shown in FIG. 5 onto the customer operation unit on the basis of the image signal. In this case, the campaign for the customer 12 is a campaign of a car-loan (loan of an automobile) as a financial product and a display screen of contents for recommending the customer 12 to consult the teller at the window of the service office, consult by a telephone, or request references is displayed. The automatic transaction apparatus 11 displays such a display screen while the financial transaction affair is being processed, that is, for a period of time such as a waiting time during the processing of the transaction affair or the like.

For example, after the customer 12 touches the key of the inquiry for the balances among the financial transactions displayed on the customer operation unit, when he inserts the cash card into the card slot of the card handling unit and inputs the personal identification number, the automatic transaction apparatus 11 accesses the account system upper apparatus 31 and obtains the information regarding the balance of the account of the customer 12. In this case, since there is a short time after the access to the account system upper apparatus 31 until the information regarding the balance of the account of the customer 12 is outputted, for example, by being displayed on the customer operation unit of the automatic transaction apparatus 11, recorded onto the passbook, or printed onto the transaction itemized account, the customer waits in front of the automatic transaction apparatus 11. In the embodiment, therefore, a display screen including the message as shown in FIG. 5 is displayed for a period of time of the financial transaction when the customer 12 waits in front of the automatic transaction apparatus 11.

In the embodiment, as obtaining means for obtaining the detailed information regarding the car-loan as a financial product, the consultant at the window, consultant by the telephone, or the request for the references can be selected. In this case, as shown in FIG. 5, buttons of “Consult right now”, “Consult by telephone”, and “Request for references” are included as selecting means for selecting the consultant at the window, the consultant by” the telephone, or the request for the references. A button of “Return to transaction” is also included as selecting means for selecting a mode to return to the display screen of the financial transaction when the customer is not interested in any of those obtaining means. When the customer 12 presses the button of “Return to transactions”, the automatic transaction apparatus 11 returns the screen to the display screen of the financial transaction. An operation history of the automatic transaction apparatus 11 by the customer 12 is stored into the history database.

When the customer 12 selects the request for the references and presses the button of “Request for references”, the automatic transaction apparatus 11 displays a display screen for selecting a method for obtaining the references as shown in FIG. 6.

Buttons of “Inform by E-mail” and “Send to your home” are included in the display screen as selecting means for selecting a mode for transmitting the references by E-mail or a mode for sending by mail, a home delivery service, or the like. Buttons of “Return to transaction” and “Back” are also included as selecting means for selecting a mode for returning to the display screen of the financial transaction or a mode for returning to the one-preceding display screen. Further, the is QR code is displayed on the display screen as obtaining means for obtaining the detailed information regarding the car-loan. In this case, it is assumed that a plurality of kinds of QR codes have previously been formed and stored in the contents file 22b. The CRM server 21 selects the QR code corresponding to the target customer ID from the QR codes stored in the contents file 22b and displays it onto the customer operation unit of the automatic transaction apparatus 11.

A guidance showing that the detailed information regarding the car-loan can be obtained by photographing the QR code by using the PDA 13 is also displayed.

In the embodiment, it is assumed that the customer 12 possesses the PDA 13 having therein the camera which can photograph the QR code and photographs the QR code displayed on the display screen by operating the PDA 13. When the customer 12 photographs the QR code displayed on the display screen by the camera built in the PDA 13 by operating the PDA 13, the QR code is fetched into the PDA 13. In this case, since the image of the QR code is stored in the storing means of the PDA 13, the QR code is fetched into the PDA 13. When the QR code is photographed, as shown in FIG. 7, it is desirable that the image of the QR code is displayed on the display screen of the display apparatus 13a in order to confirm the photographed QR code by the customer 12.

The customer 12 operates the PDA 13 which obtained the QR code at a desired time, for example, at timing after completion of the inquiry for the balances as a financial transaction and at a desired place, for example, at home, allows the PDA 13 to decode the QR code, and allows the information shown by the QR code to be displayed on the display screen of the display apparatus 13a. For example, when the information shown by the QR code is character information, as shown in FIG. 8, the detailed information regarding the car-loan is displayed as character information on the display screen of the display apparatus 13a of the PDA 13. Thus, the customer 12 can obtain the more detailed information regarding the car-loan.

A URL (Uniform Resource Locator) as shown in FIG. 9 can be also used as information shown by the QR code. In this case, the customer 12 operates the PDA 13, connects it to the Internet, and can display a Web page shown by the URL onto the display screen of the display apparatus 13a. Thus, the customer 12 can browse the Web page on which the detailed information regarding the car-loan has been shown. The customer 12 can also browse the Web page shown by the URL by operating an information processing apparatus such as a personal computer or the like.

The information shown by the QR code can be also image information such as photograph, picture, or the like. In this case, as detailed information regarding the car-loan, for example, a photograph of an automobile serving as a target of the car-loan is displayed on the display screen of the display apparatus 13a of the PDA 13 as shown in FIG. 10. Thus, the customer 12 can easily recognize the automobile as a target of the car-loan. The photograph can be also set as a waiting display screen of the display apparatus 13a.

Further, the information shown by the QR code can be also audio information such as music, voice, or the like. In this case, a voice sound for describing the details regarding the car-loan is generated from the audio output apparatus of the PDA 13. Thus, the customer 12 can easily recognize the details of the car-loan. Since the customer 12 can generate the voice sound by operating the PDA 13 which obtained the QR code at desired time and place, the information is not listened to by others and his privacy can be held. Moreover, the audio information can be also a music such as a commercial song of the automobile serving as a target of the car-loan. In this case, the customer 12 can also set the music as a phone melody of the PDA 13, that is, a melody which notifies that a telephone call is coming.

The information shown by the QR code can be also information such as ticket information or the like of a coupon ticket, a discount admission ticket, an exchange ticket, or the like. In this case, if the information shown by the QR code indicates, for example, an exchange ticket of a miniature of the automobile serving as a target of the car-loan as detailed information regarding the car-loan, the image of the photographed QR code is displayed as it is onto the display screen of the display apparatus 13a. The customer 12 can use the QR code as an exchange ticket of the miniature by allowing the QR code to be read out by a reading apparatus at an exchange place of the miniature.

As mentioned above, in the embodiment, when the customer 12 operates the automatic transaction apparatus 11 and executes the financial transaction, the message or the like of the campaign of the financial products is displayed on the customer operation unit of the automatic transaction apparatus 11 for a period of time during the processing of the financial transaction or the like. The QR code is displayed as obtaining means for obtaining the information such as detailed information of the financial products. Therefore, by operating the PDA 13 possessed by himself and photographing the QR code, the customer 12 can obtain the QR code. Thus, the customer 12 can confirm the information shown by the QR code at desired time and place by displaying it onto the display screen by operating the PDA 13. Therefore, the customer 12 can carefully examine the information such as detailed information of the financial products. In this case, the information is not seen or listened to by others and the privacy of the customer 12 can be held.

Even when the customer 12 does not have an enough time or want to meet and talk or consult the operator at the window, he can obtain the detailed information regarding the interested goods. On the other hand, the financial institution can provide the detailed information to the customer 12 who is interested in the goods and a goods contract conclusion ratio can be raised. Further, costs per unit price of the goods contract conclusion can be suppressed as compared with those in the case where the operator faces the customer and explain to him.

Since there is no need to obtain the information through a communication line such as a telephone line or the like, the customer 12 can obtain the information without spending a communication fee. Since the QR code is merely displayed on the display apparatus of the automatic transaction apparatus 11, the information can be provided by a simple mechanism without modifying the conventional automatic transaction apparatus 11.

The second embodiment of the invention will now be described. Component elements having the same structures as those in the first embodiment are designated by the same reference numerals and their description is omitted here. An explanation about the same operation and effects as those in the first embodiment is also omitted here.

FIG. 11 is a diagram showing an example of a display screen of a display apparatus of a personal digital assistant in the second embodiment of the invention.

In the second embodiment, the QR code displayed on the display screen of the customer operation unit of the automatic transaction apparatus 11 as shown in FIG. 6 is not a code selected from the QR codes stored in the contents file 22b but formed by the QR code forming unit 24. In this case, the QR code forming unit 24 forms the different QR code every customer 12 on the basis of the customer fundamental attributes information of each customer 12, the message to each customer 12, the display screen construction information, and the like. Besides the QR code formed by the QR code forming unit 24, the display screen forming unit 25 forms the display screen which is displayed on the display apparatus of the automatic transaction apparatus 11 on the basis of the customer fundamental attributes information, the message, and the like.

As mentioned above, in the embodiment, since the different QR code is formed every customer 12, for example, as shown in FIG. 11, the name of the customer 12 can be inserted into the information. That is, a QR code showing information of “One to One” can be formed. Therefore, since the information of “One to One” is displayed on the display apparatus 13a of the PDA 13, the customer 12 can feel affection for the information. The information of further proper contents can be provided for each customer 12.

The third embodiment of the invention will now be described. Component elements having the same structures as those in the first and second embodiments are designated by the same reference numerals and their description is omitted here. An explanation about the same operation and effects as those in the first and second embodiments is also omitted here.

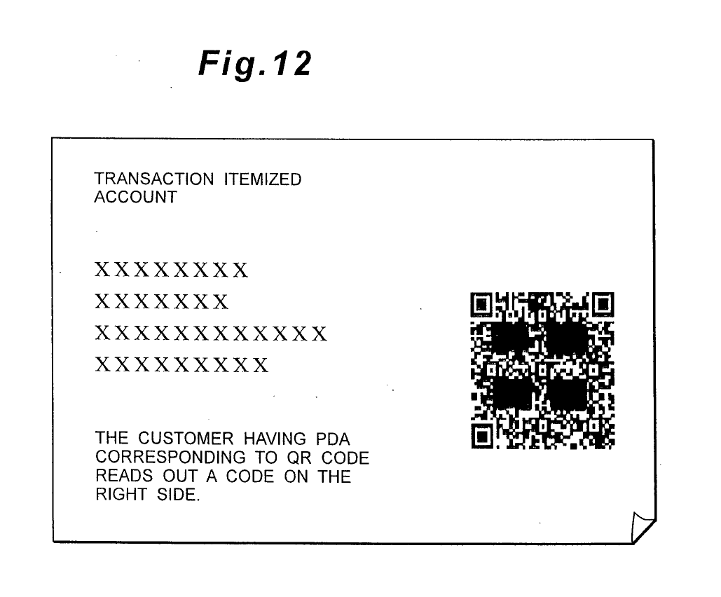

FIG. 12 is a diagram showing an example of a transaction itemized account in the third embodiment of the invention.

In the embodiment, the QR code is not displayed on the display screen of the customer operation unit of the automatic transaction apparatus 11 but printed onto the transaction itemized account. In this case, when the financial transaction executed by operating the automatic transaction apparatus 11 by the customer 12 is finished, a printing unit of the automatic transaction apparatus 11 prints the transaction itemized account and issues it. As shown in FIG. 12, in addition to the information regarding the financial transaction executed by the customer 12, the QR code is printed. When the customer 12 operates the PDA 13 and photographs the QR code printed on the transaction itemized account by the camera built in the PDA 13, the QR code is fetched into the PDA 13.

As mentioned above, in the third embodiment, since the QR code is printed onto the transaction itemized account, the customer 12 can photograph the QR code by operating the PDA 13 at desired time and place. Therefore, the customer 12 can carefully photograph the QR code. When the customer 12 operates the automatic transaction apparatus 11, even if he does not possess the PDA 13, he can obtain the QR code.

Further, when the automatic transaction apparatus 11 is operated, since there is no need to photograph the QR code, a time which is required when each customer 12 exclusively occupies the automatic transaction apparatus 11 can be shortened. A throughput of the automatic transaction apparatus 11 is improved.

The fourth embodiment of the invention will now be described. Component elements having the same structures as those in the first to third embodiments are designated by the same reference numerals and their description is omitted here. An explanation about the same operation and effects as those in the first to third embodiments is also omitted here.

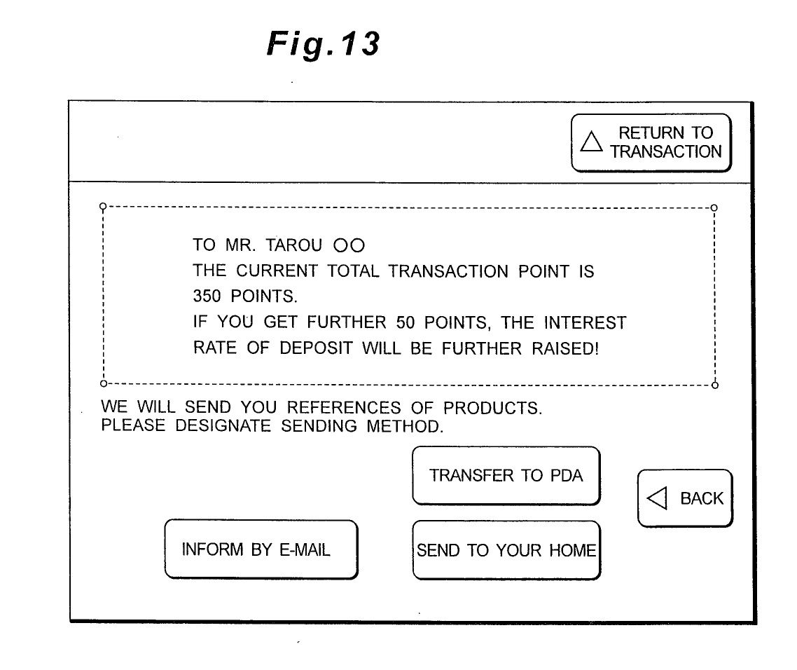

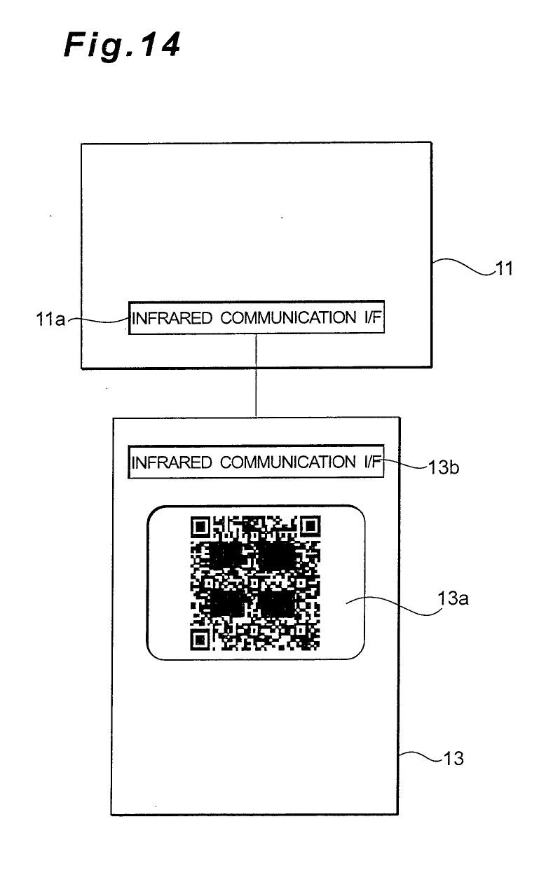

FIG. 13 is a diagram showing an example of a message display screen of a customer operation unit in the fourth embodiment of the invention. FIG. 14 is a diagram showing the operation for transferring a QR code from an automatic transaction apparatus to a personal digital assistant in the fourth embodiment of the invention.

In the fourth embodiment, the QR code is not displayed on the display screen of the customer operation unit of the automatic transaction apparatus 11 but transferred to the PDA 13 by infrared communication. In this case, on the display screen including the message as shown in FIG. 5 described in the first embodiment mentioned above, when the customer 12 selects the mode for requesting for the references and presses the button of “Request for references”, the automatic transaction apparatus 11 displays a display screen for selecting a method of obtaining the references as shown in FIG. 13. The buttons of “Inform by E-mail” and “Send to your home” are included in the display screen as selecting means for selecting the mode for transmitting the references by E-mail or the mode for sending by mail, a home delivery service, or the like. The buttons of “Return to transaction” and “Back” are also included as selecting means for selecting the mode for returning to the display screen of the financial transaction or the mode for returning to the one-preceding display screen. Further, a button of “Transfer to PDA” is included in the display screen as selecting means for selecting a mode for transferring the references to the PDA 13.

When the customer 12 presses the button of “Transfer to PDA”, as shown in FIG. 14, the QR code is transferred from the automatic transaction apparatus 11 to the PDA 13 which the customer 12 possesses by the infrared communication. In the embodiment, it is assumed that the automatic transaction apparatus 11 has an infrared communication interface 11a and the PDA 13 has an infrared communication interface 13b. When the customer 12 operates the PDA 13 and allows a photosensing unit of the infrared communication interface 13b of the PDA 13 to face a light emitting unit of the infrared communication interface 11a of the automatic transaction apparatus 11, the QR code is transferred to the PDA 13 by the infrared communication. In this case, since the image of the QR code is stored into the storing means of the PDA 13, the QR code is fetched into the PDA 13. As shown in FIG. 14, in order to confirm the transferred QR code by the customer 12, it is desirable that the image of the QR code is displayed onto the display screen of the display apparatus 13a.

As mentioned above, in the embodiment, since the QR code is transferred by the infrared communication, even if the PDA 13 does not have a camera, the QR code can be obtained so long as it has the infrared communication interface 13b. Since the automatic transaction apparatus 11 can recognize the transfer of the QR code, the fact that the customer 12 has operated the PDA 13 and obtained the QR code can be stored into the history database of the CRM server 21 as an operation history of the operations of the automatic transaction apparatus 11 which have been executed by the customer 12 so far. Therefore, the customer information can be more properly managed.

The QR code can be also transferred by communicating means other than the infrared communication. For example, it can be transferred by radio communication using a radio wave or can be also transferred by wire communication using a communication cable.

The present invention is not limited to the foregoing embodiments but many modifications and variations are possible within the spirit and scope of the appended claims of the invention.

1. An automatic transaction apparatus information providing system comprising:
(a) an automatic transaction apparatus which executes a financial transaction; and
(b) a customer relationship management server which forms guide information of contents corresponding to a customer who operates said automatic transaction apparatus on the basis of a customer ID of said customer,
wherein
(c) said automatic transaction apparatus displays said guide information during the financial transaction, and
(d) a read code showing detailed information of said guide information is provided.

2. The automatic transaction apparatus information providing system according to claim 1, wherein said automatic transaction apparatus displays said read code so that it can be photographed.

3. The automatic transaction apparatus information providing system according to claim 1, wherein said automatic transaction apparatus prints said read code.

4. The automatic transaction apparatus information providing system according to claim 1, wherein said automatic transaction apparatus transfers said read code.

5. The automatic transaction apparatus information providing system according to claim 1, further comprising a read code forming unit which forms the read code every said customer.

6. The automatic transaction apparatus information providing system according to claim 1, wherein said read code is a QR code.

7. The automatic transaction apparatus information providing system according to claims 1, wherein said read code is fetched into a personal digital assistant of said customer.

8. An automatic transaction apparatus comprising:
(a) an ID obtaining unit which obtains a customer ID of a customer; and
(b) a customer operation unit which displays guide information of contents corresponding to said customer,
wherein
(c) said guide information is displayed during a financial transaction, and
(d) a read code showing detailed information of said guide information is provided.

9. The automatic transaction apparatus according to claim 8, wherein said read code is displayed to said customer operation unit so that it can be photographed.

10. The automatic transaction apparatus according to claim 8, further comprising a print unit which prints a transaction itemized account and issues it, and
wherein said print unit prints said read code onto said transaction itemized account.

11. The automatic transaction apparatus according to claim 8, wherein said read code is transferred.

12. The automatic transaction apparatus according to claim 8, wherein said read code is a QR code.

13. The automatic transaction apparatus according to claim 8, wherein said read code is fetched into a personal digital assistant of said customer.
